(19) United States
(12) Patent Application Publication
(10) Pub. No.: US 2002/0187372 A1
(43) Pub. Date: Dec. 12, 2002

(54) Lithium ion battery passive charge equalization

(76) Inventors: John C. Hall, Rancho Palos Verdes, CA (US); Anna M. Lackner, Calabasas, CA (US)

Correspondence Address: Gregory Garmong, P.O. Box 12460, Zephyr Cove, NV, 89448, US

(21) Appl. No.: 09/855,235

(22) Filed: May 14, 2001

(51) Int. Cl. H01M 14/00; H01M 4/58; H01M 4/52; H01M 4/48; H01M 4/66; H01M 2/16; H01M 4/50; H01M 10/44

(52) U.S. Cl. 429/7; 429/231.1; 429/231.5; 429/223; 429/231.6; 429/231.8; 429/245; 429/254; 429/94; 429/224; 429/231.3; 429/50

(57) ABSTRACT

An electrochemical battery includes at least two electrically interconnected electrochemical cells. Each electrochemical cell has an anode including carbon, and a cathode including a modified lithium metal oxide including at least one additional element selected from the group consisting of nickel, aluminum, magnesium, titanium, and combinations thereof. A Schottky diode is connected between the anode and the cathode. The battery is balanced by fully discharging it to a fully discharged state, and then operated in cycles of charging and discharging.

This invention relates to an electrochemical storage battery and, more particularly, to the operation of a multicell battery with nonuniform individual electrochemical cells.

### BACKGROUND OF THE INVENTION

An electrochemical battery stores electrical energy by an electrochemical reaction termed charging, and then later delivers the stored electrical energy by reversal of the reaction in a process termed discharging. The battery is typically formed of a number of individual electrochemical cells. Each electrochemical cell has characteristic voltage and current properties. The electrical cells are electrically interconnected to provide the desired voltage and current characteristics required for the battery.

Ideally, all of the electrochemical cells in the battery would perform in an identical fashion. In practice, the individual electrochemical cells vary somewhat in their charging and discharging characteristics. The variations between the electrochemical cells may lead to problems in the use of the battery.

For example, in a conventional lithium-ion battery the electrochemical cells may be balanced by fully charging the battery prior to entry into a series of charging and discharging cycles. Generally, such approaches involve active electronic charge balancing by shifting charge between cells, individually charging the cells, or shunting charge past fully charged cells. In one approach, the battery is charged until one of the cells reaches full capacity, charging is discontinued for that fully charged cell, and the remaining cells are charged in a similar fashion until all of the cells are fully charged. These techniques require active monitoring and controlling of the charging of the cells, and utilize additional circuitry that adds weight and volume to the cells. This added weight and volume is highly disadvantageous for applications such as battery systems utilized in spacecraft.

There is a need for an improved approach to the operation of battery systems, particularly in respect to the balancing of the battery. The present invention fulfills this need, and further provides related advantages.

### SUMMARY OF THE INVENTION

The present invention provides a structure of an electrochemical battery and its individual electrochemical cells. This structure permits a passive charge balancing and equalization of the charge in the individual cells prior to normal charging/discharging cycles, or at intermediate times amidst charging/discharging cycles. The structure prevents damage to the electrochemical cells by reversal of the charge of the cells. The approach of the invention requires the addition of only a small, lightweight component to the weight of the cells themselves, and avoids the need for active charge balancing apparatus and circuitry. Consequently, the present passive approach is more reliable than an active charge balancing approach.

In accordance with the invention, an electrochemical battery comprises at least two electrically series-interconnected electrochemical cells. Each electrochemical cell comprises an anode, a cathode formed of a cathode active material having a full-discharge cell potential more negative than a negative bypass voltage, and a cell current bypass connected between the anode and the cathode, the cell current bypass being active at voltages more negative than the negative bypass voltage.

Desirably, the anode includes an anode active material comprising carbon, and the cathode includes a cathode active material comprising a modified lithium metal oxide. The cell current bypass comprises a Schottky diode. In an embodiment developed by the inventors, the negative bypass voltage was about −0.3 volts.

In a preferred embodiment, an electrochemical battery comprises at least two electrically series-interconnected electrochemical cells. Bach electrochemical cell comprises an anode comprising carbon, and a cathode comprising a modified lithium metal oxide including at least one additional element selected from the group consisting of nickel, aluminum, magnesium, and titanium, and combinations thereof. Additionally, a limiting Schottky diode is connected between the anode and the cathode to serve as the cell current bypass.

The additional element added to the lithium metal oxide typically is nickel, aluminum, and/or cobalt. Some examples of operable cathode materials include LiNiCoAlO₂, LiNiCoO₂, and LiNiO₂.

In another battery according to the invention, the anode preferably includes a copper anode current collector, and carbon particles supported on the anode current collector. The cathode includes an aluminum cathode current collector, and modified lithium metal oxide particles supported on the cathode current collector. The separator comprises a layer of a microporous polymer such as polyvinylidene fluoride (PVDF). The electrolyte solution comprises a mixture of an electrically conductive lithium salt and a mixture of organic carbonates. In one embodiment, the anode, the cathode, and the separator are each individually planar and are rolled into a spiral or shaped into a prismatic form.

The present invention also provides for a charge balancing procedure in which the battery according to the invention is fully discharged, and thereafter operated in a series of charging and discharging cycles. This approach is to be contrasted with a conventional approach where the battery is fully charged during charge balancing, not fully discharged. The conventional approach does not utilize discharging during charge balancing, because the conventional structure of the electrochemical cells in the battery might force some of them into reverse charging and lead to damage of those cells.

The present approach adds only the cell current bypass to the structure of the individual electrochemical cells. The Schottky diode provides such a light-weight, inexpensive, passive cell current bypass, but other operable devices may be used. The present approach also uses a modified cathode material. Because the battery has no active charge balancing circuitry, the total weight of the battery of the invention is less than that of a conventional battery utilizing active charge-balancing circuitry and components.

Other features and advantages of the present invention will be apparent from the following more detailed description of the preferred embodiment, taken in conjunction with the accompanying drawings, which illustrate, by way of example, the principles of the invention. The scope of the invention is not, however, limited to this preferred embodiment.

### BRIEF DESCRIPTION OF THE DRAWINGS

FIG. 1 is a schematic sectional view of a single metal oxide/carbon electrochemical cell;

FIG. 2 is a circuit diagram of a battery having three electrochemical cells;

FIG. 3 is a block flow diagram of an approach for using the battery of the invention; and

FIG. 4 is a graph reporting comparative test results for the present approach and prior approaches, in discharge energy as a function of number of cycles of charging/discharging.

### DETAILED DESCRIPTION OF THE INVENTION

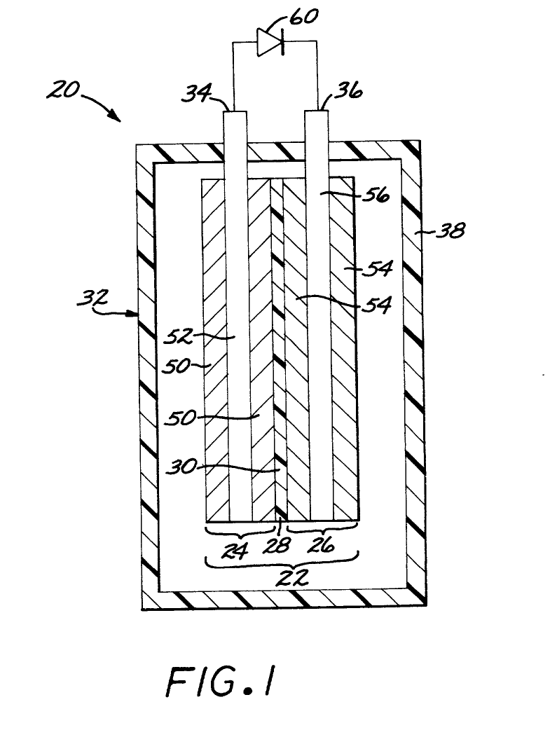

FIG. 1 schematically illustrates an electrochemical cell 20. The electrochemical cell comprises an active element 22. A single active element 22 is shown in the drawing, but there are typically multiple active elements in each electrochemical cell 20. The active element 22 includes an anode 24, a cathode 26, and a separator 28, made of porous, electrically nonconductive material, between the anode 24 and the cathode 26. An electrolyte 30 enabling ion transport is disposed between the anode 24 and the cathode 26. The electrolyte 30 is typically impregnated into the porous separator 28, the anode 24, and the cathode 26. The active element 22 is enclosed within a sealed housing 32. The housing 32 is hermetically sealed against leakage of the contents of the sealed housing 32 and against intrusion of external elements. Leads 34 and 36 for the anode 24 and for the cathode 26, respectively, extend through a wall 38 of the sealed housing 32 to provide external connection to the anode 24 and to the cathode 26. Electrical current is carried to and from the anode 24 of each electrochemical cell 20 through the lead 34, Electrical current is carried to and from the cathode 26 of each electrochemical cell 20 through the lead 36.

The anode 24 typically is formed as layers of an anode active material 50 supported on each side of an anode current collector 52. The cathode 26 is typically formed as layers of a cathode active material 54 supported on each side of a cathode current collector 56. The current collectors 52 and 56 are in electrical communication with the respective leads 24 and 26. In the case of the preferred lithium-ion cell, the anode active material 50 releases lithium ions upon discharging of the electrochemical cell 20 and accepts lithium ions upon charging of the electrochemical cell. The cathode active material 54 accepts lithium ions upon discharging of the electrochemical cell 20 and releases lithium ions upon charging of the electrochemical cell.

The anode current collector 52 and its anode active material 50, the cathode current collector 56 and its cathode active material 54, the separator 28, and the electrolyte 30 may be made of any operable materials and have any operable physical arrangement and form. A wide variety of operable materials and physical arrangements are known in the art. For example, in a preferred approach, the active elements 22 are individually planar and in a flexible form, and wound into a spiral within the sealed housing 32.

In the case of the preferred spiral active element 22, the presently most preferred dimensions and materials of construction of these elements are an anode 24 about 0.003-0.010 inch thick and made of a copper anode current collector 52 with a thin film on each side thereof of carbon-containing anode active material 50 made of carbon particles in a polymer binder that is porous to the electrolyte, preferably polyvinylidene fluoride; a cathode 26 about 0.004-0.012 inch thick and made of an aluminum cathode current collector 56 with a thin film on each side thereof of modified lithium metal oxide cathode material 54 (of a composition to be discussed subsequently) and conductive carbon particles in a polymer binder that is porous to the electrolyte, preferably polyvinylidene fluoride; a separator 28 about 0.002-0.004 inch thick and made of a hybrid polymer with silica particles in a polymer binder that is electrically nonconducting but is porous to the electrolyte, preferably polyvinylidene fluoride (PVDF); and an electrolyte of 1 molar LiPF₆ in a 2:1 mixture by volume of ethylene carbonate and dimethyl carbonate. (As used herein, reference to a metal includes the pure metal and its alloys, unless otherwise indicated. That is, “copper” includes pure copper and alloys of copper.) These dimensions and materials of construction are presented by way of illustration of the preferred embodiment and are not limiting of the invention, which is applicable to other forms of battery cells and lithium-ion battery cells as well.

The cathode active material exhibits a characteristic wherein its full-discharge cell potential is more negative than a negative bypass voltage. In the preferred case, the cathode active material is a modified lithium metal oxide including at least one additional element selected from the group consisting of nickel, aluminum, magnesium, titanium, and combinations thereof. Operable examples of such materials in their general forms with a specific example for each class are set forth in the following table.

| | General | |
|---|---|---|
| General Name | Formula | Specific Example |
| Lithium nickel oxide | LiNiO₂ | LiNiO₂ |
| Lithium nickel | LiNi₍ₗ₋ₐ₎AlₐO₂ | LiNi_{0.75}Al_{0.25}O₂ |
| aluminum oxide | | |
| Lithium nickel cobalt | LiNi₍ₗ₋ₓ₎CoₓO₂ | LiNi_{0.8}Co_{0.2}O₂ |
| oxide | | |
| Lithium nickel cobalt | LiNi₍ₗ₋ₓ₎CoₓO_{(2-z)}F_{z} | LiNi_{0.8}Co_{0.2}O_{1.95}F_{0.05} |
| oxy-fluoride | | |
| Lithium nickel cobalt | LiNi₍ₗ₋ₓ₋ₐ₎CoₓAlₐO₂ | LiNi_{0.8}Co_{0.15}Al_{0.05}O₂ |
| aluminum oxide | | |
| Lithium nickel cobalt | LiNi_{(l-x-b)}CoₓFe_{b}O₂ | LiNi_{0.7}Co_{0.2}Fe_{0.1}O₂ |
| iron oxide | | |
| Lithium nickel cobalt | LiNi_{(l-x-y)}CoₓMn_{y}O₂ | LiNi_{0.7}Co_{0.2}Mn_{0.1}O₂ |
| manganese oxide | | |
| Lithium nickel cobalt | LiNi_{(l-x-y-a)}CoₓMn_{y}AlₐO₂ | LiNi_{0.75}Co_{.125}Mn_{.05}Al_{.075}O₂ |
| manganese aluminum | | |
| oxide | | |
| Lithium nickel cobalt | LiNi_{(l-x-c-d)}CoₓTi_{c}Mg_{d}O₂ | LiNi_{0.7}Co_{0.2}Ti_{0.05}Mg_{0.05}O₂ |
| titanium magnesium | | |
| oxide | | |

Of these cathode active materials, lithium nickel cobalt aluminum oxide is presently most preferred.

These materials have a full-discharge cell potential that is more negative than about −0.3 volts, the voltage at which the copper anode material is oxidized. By contrast, the full-discharge cell potential of LiCoO₂ is greater than −0.3 volts.

A cell current bypass is connected between the anode 24 and the cathode 26. This cell current bypass is active (that is, conducts current between the anode 24 and the cathode 26 to short circuit the electrochemical cell) at voltages more negative than the negative bypass voltage. In the case of the modified lithium-oxide cathode active material discussed above, the cell current bypass is selected to conduct current at voltages more negative than −0.3 volts. Any imposed current on the electrochemical cell under applied voltages more negative than −0.3 volts is conducted around the cell by the cell current bypass, protecting the electrochemical cell against a malfunction such as voltage reversal. At voltages more positive than −0.3 volts, the cell current bypass is inoperative and does not conduct current, so that the electrochemical cell functions normally in charging and discharging cycles. An available passive component to accomplish this function is a Schottky diode 60 connected between the anode 24 and the cathode 26. Preferably, the Schottky diode 60 is externally connected between the anode 24 and the cathode 26, specifically between the leads 34 and 36.

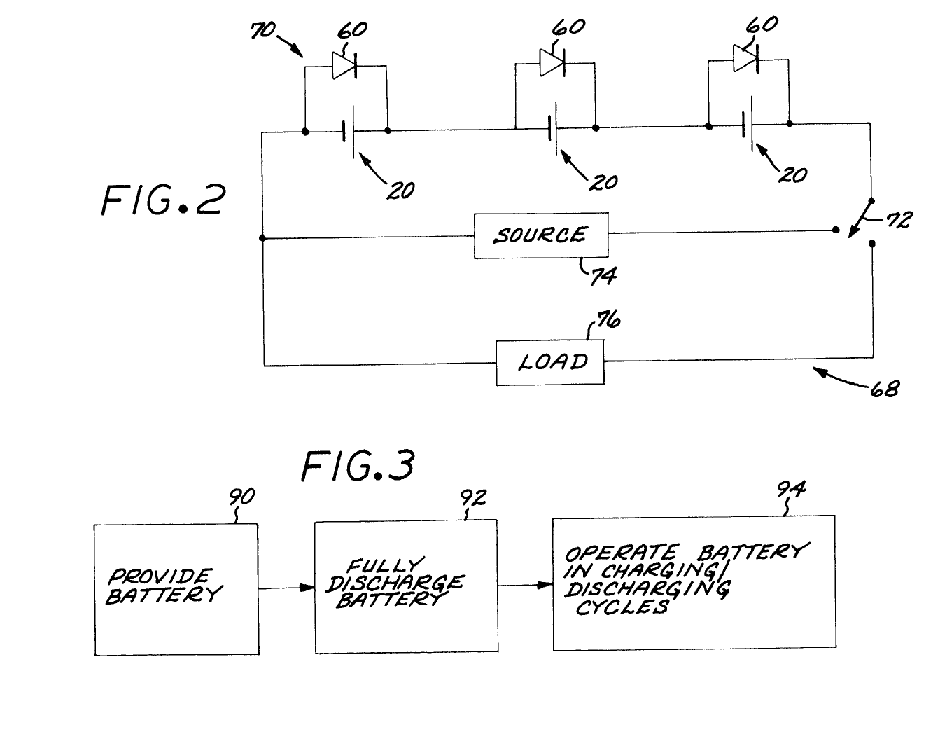

FIG. 2 is a circuit diagram of a battery system 68 including a battery 70 having three schematically illustrated electrochemical cells 20 in electrical series. These electrochemical cells 20 use the modified lithium-oxide cathode active material described above, and the Schottky diode 60 connected between the terminals. Three electrochemical cells 20 are shown, but the battery may include more or fewer cells. In normal situations, these three electrochemical cells 20 are not identical in performance. The battery 70 may be alternatively connected by a switch 72 to a voltage and current source 74 for charging and to a load 76 for discharging. This switching is utilized both during the balancing of the charge of the individual cells of the battery and during charging/discharging cycles of the battery system 68.

An approach for operating a battery system is illustrated in FIG. 3. The battery, such as the battery 70, and the battery system, such as the battery system 68, are provided, numeral 90. To balance the battery 70, the battery 70 is connected to the load 76 and fully discharged, numeral 92. The individual electrochemical cells discharge to zero volts at different rates and reach zero volts at different times. The combination of the cathode active material and the presence of the Schottky diode for each of the electrochemical cells prevents each cell from going into a condition of voltage reversal that potentially damages one or more of the cells, as the cells reach zero voltage. This approach is to be contrasted with the conventional approach for balancing the cells of the battery, wherein the battery is fully charged with overcharging being regulated and prevented by active monitoring circuitry.

After the balancing of the battery 70 is completed in step 92, the battery system 68 and the battery 70 are operated in normal cycles of charging and discharging, numeral 94. Battery systems that have two or more hard-wired batteries may be alternatively balanced and utilized in service. In many battery systems, electrical circuitry is provided such that the various individual electrochemical cells may be interconnected in various arrangements during the course of a mission, as various types of performance are required or in the event of the failure of a cell. Thus, the entire group of electrochemical cells may be segmented to form various battery arrangements. These various battery arrangements may be utilized to advantage in the present approach. For example, the cells may be segmented to form two battery arrangements. One of the battery arrangements may be used in service while the other is balanced by the present invention.

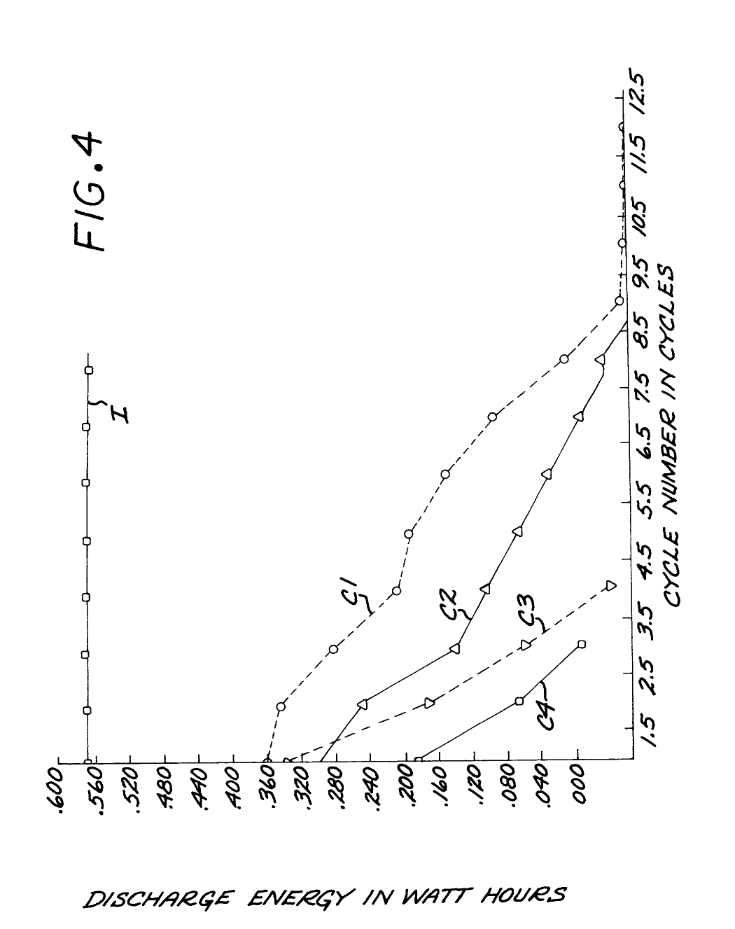

The approach of the invention was practiced using the preferred lithium nickel cobalt aluminum oxide cathode active material discussed above, matched with graphite anode using a copper grid, and the other cell structure and procedures discussed earlier. The discharge energy in watt-hours as a function of the number of cycles of charging/discharging is set forth in FIG. 4, as line I. There is little loss of discharge energy with increasing numbers of cycles. For comparison, the discharge energy as a function of the number of cycles is also presented for LiCoO₂ cathode active material, using graphite anode and a nickel grid current collector (line C1), coke anode and using a nickel grid (line C2), matched with graphite anode and using a copper grid (line C3), and with coke anode and using a copper grid (line C4). The comparison lines C1-C4 all exhibit great decreases in the discharge energy after only a few cycles.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. An electrochemical battery comprising at least two electrically interconnected electrochemical cells, each electrochemical cell comprising:
an anode comprising carbon;
a cathode comprising a modified lithium metal oxide including at least one additional element selected from the group consisting of nickel, aluminum, magnesium, titanium, and combinations thereof; and
a Schottky diode connected between the anode and the cathode.

2. The battery of claim 1, wherein the at least one additional element comprises nickel.

3. The battery of claim 1, wherein the at least one additional element comprises nickel, and the modified lithium metal oxide further comprises cobalt.

4. The battery of claim 1, wherein the at least one additional element comprises nickel and aluminum.

5. The battery of claim 1, wherein the anode comprises
a copper anode current collector, and
carbon particles supported on the anode current collector.

6. The battery of claim 1, wherein the cathode comprises
an aluminum cathode current collector, and
modified lithium metal oxide particles supported on the cathode current collector.

7. The battery of claim 1, wherein the separator comprises
a layer of microporous polyvinylidene fluoride.

8. The battery of claim 1, wherein the electrolyte comprises a mixture of an electrically conductive lithium salt and an organic carbonate.

9. The battery of claim 1, wherein
the anode, the cathode, and the separator are planar and are rolled into a spiral.

10. The battery of claim 1, wherein
the anode, the cathode, and the separator are planar and are shaped into a prismatic form.

11. The battery of claim 1, wherein the modified lithium metal oxide comprises a combination of elements selected from the group consisting of lithium nickel oxide, lithium nickel aluminum oxide, lithium nickel cobalt oxide, lithium nickel cobalt oxy-fluoride, lithium nickel cobalt aluminum oxide, lithium nickel cobalt iron oxide, lithium nickel cobalt manganese oxide, lithium nickel cobalt manganese aluminum oxide, and lithium nickel cobalt titanium magnesium oxide, and combinations thereof.

12. An electrochemical battery comprising at least two electrically interconnected electrochemical cells, each electrochemical cell comprising:
an anode;
a cathode comprising a cathode active material which exhibits a full-discharge cell potential that is more negative than a negative bypass voltage; and
a cell current bypass connected between the anode and the cathode, the cell current bypass conducting current between the anode and the cathode to short circuit the electrochemical cell only at voltages more negative than the negative bypass voltage.

13. The battery of claim 12, wherein the cathode active material comprises a modified lithium metal oxide including at least one additional element selected from the group consisting of nickel, aluminum, magnesium, titanium, and combinations thereof.

14. The battery of claim 12, wherein the cell current bypass comprises a Schottky diode.

15. A method of operating a battery system, comprising the steps of providing an electrochemical battery comprising at least two electrically interconnected electrochemical cells, each electrochemical cell comprising:
an anode comprising carbon,
a cathode comprising a modified lithium metal oxide including at least one additional element selected from the group consisting of nickel, aluminum, magnesium, titanium, and combinations thereof, and
a Schottky diode connected between the anode and the cathode; fully discharging the battery; and thereafter
operating the battery in a series of charging and discharging cycles.

16. The method of claim 15, wherein the at least one additional element comprises nickel.

17. The method of claim 15, wherein the at least one additional element comprises nickel, and the modified lithium metal oxide further comprises cobalt.

18. The method of claim 15, wherein the at least one additional element comprises nickel and aluminum.
